(19) United States
(12) Patent Application Publication
(10) Pub. No.: US 2026/0307698 A1
(43) Pub. Date: Oct. 8, 2026

(54) HEIGHT ADJUSTABLE WHEELBARROW AND HEIGHT ADJUSTMENT MECHANISM

(71) Applicant: Florian Stöckle, Haar (DE)

(72) Inventor: Florian Stöckle, Haar (DE)

(21) Appl. No.: 19/456,661

(22) Filed: Jan. 22, 2026

Related U.S. Application Data
(63) Continuation of application No. 19/175,399, filed on Apr. 10, 2025.
(60) Provisional application No. 63/783,347, filed on Apr. 4, 2025.

(51) Int. Cl. B62B 1/18; B62B 1/20

(52) U.S. Cl. CPC B62B 1/186; B62B 1/20; B62B 2206/06

(57) ABSTRACT

A height-adjustable wheelbarrow can include a loading trough supported by a frame assembly and a first wheel arranged at a front portion of the wheelbarrow. The frame assembly is structured to have the first wheel rotatably coupled thereto and to act as a ground engaging leg to support the wheelbarrow at rest. A height adjustment mechanism can be configured to adjust a vertical spacing between the loading trough and the second wheels. The height adjustment mechanism (can include a support structure carrying the second wheels or the loading trough and an actuation mechanism configured to lock, release or control adjustment of a vertical position of the support structure relative to the other of the loading trough or the second wheels.

### CROSS-REFERENCE TO RELATED APPLICATIONS

The present application is a continuation application of U.S. patent application Ser. No. 19/175,399, which was filed on Apr. 10, 2025 and claims priority to U.S. Provisional Patent Application No. 63/783,347, which was filed on Apr. 4, 2025.

### TECHNICAL FIELD

The present invention relates to a height adjustable wheelbarrow. Furthermore, the present invention relates to a height adjustment mechanism for a wheelbarrow.

### BACKGROUND

Wheelbarrows are essential tools in construction, gardening, and agriculture, used for transporting heavy materials across uneven terrain. Despite the broad range of designs—ranging from flat-bed carts to deep loading troughs, and from solid to pneumatic wheels—conventional wheelbarrows often rely on a fixed tubular frame that cannot be adjusted to accommodate users of different heights or ergonomic needs. This limitation frequently leads to poor posture during operation, resulting in strain on the user's back, particularly when transporting heavy loads over extended periods.

US 20240157989 A1 discloses a height-adjustable wheelbarrow comprising a loading trough attached to a frame, a first wheel arranged at a front portion of the wheelbarrow, said front portion being arranged with respect to a longitudinal direction of the wheelbarrow, a second wheel arranged at a rear portion of the wheelbarrow, said rear portion being arranged with respect to the longitudinal direction of the wheelbarrow, and a device for adjusting the height of the wheelbarrow.

The device is configured to adjust a vertical position of the second wheel relative to the loading trough and comprises a telescopic tube connected at a first axial end portion to the frame and/or the loading trough and at a second axial end portion to a mounting of the second wheel, as well as an actuating device arranged at the telescopic tube, the actuating device being configured to adjust a tube length of the telescopic tube.

### SUMMARY

The aforementioned height-adjustable wheelbarrow, however, remains limited in its ability to provide consistent stability and handling under dynamic conditions. In particular, when maneuvering over uneven surfaces or while turning, the user is often required to compensate manually for shifting loads and imbalance. This increases physical effort and may reduce control, especially during transport of heavy or asymmetrical materials, potentially affecting both comfort and operational safety.

In view of these limitations, there remains a need for wheelbarrows with improved handling dynamics, user ergonomics, and adaptability to different terrain and loading conditions. In particular, solutions that reduce physical strain and improve stability—both during straight transport and turning—are desirable, especially when maneuvering heavy or unbalanced loads.

According to a first aspect, a height-adjustable wheelbarrow is provided.

Embodiments of the height-adjustable wheelbarrow can include:
a loading trough supported by a frame assembly;
a first wheel arranged at a front portion of the wheelbarrow, wherein the frame assembly is structured to have the first wheel rotatably coupled thereto and to act as a ground engaging leg to support the wheelbarrow at rest;
two or more second wheels arranged at a rear portion of the wheelbarrow; and
a height adjustment mechanism configured to adjust a vertical spacing between the loading trough and the second wheels, the height adjustment mechanism comprising:
a support structure carrying the second wheels or the loading trough; and
an actuation mechanism configured to lock, release or control adjustment of a vertical position of the support structure relative to the other of the loading trough or the second wheels.

According to a second aspect, a height adjustment mechanism for a wheelbarrow is provided. The mechanism can include:
a support structure;
an actuation mechanism operatively coupled to the support structure and configured to lock, release, or control adjustment of a vertical position of the support structure; and
two rear wheels mounted to the support structure;
   wherein the support structure is configured to be mounted to a frame assembly or a loading trough of the wheelbarrow to adjust a vertical spacing between the rear wheels and the loading trough.

The loading trough is the primary container or basin of the wheelbarrow, also commonly referred to as a tray or bucket, designed to carry transported materials such as soil, gravel, or tools. It is supported by the frame assembly and may vary in depth and shape depending on the intended use. The trough is typically positioned above the wheels and between the handles.

The frame assembly refers to the structural framework of the wheelbarrow, typically composed of tubular or rigid members. It supports the loading trough and connects the front and rear wheel components. The frame assembly also comprises handles of the wheelbarrow and acts as a load-bearing and stabilizing structure, particularly when the wheelbarrow is at rest.

The first wheel can be the front wheel of the wheelbarrow, usually a single central wheel rotatably mounted to the frame assembly. It can provide maneuverability and rolling support. When the wheelbarrow is stationary and tilted forward, the first wheel, in combination with the frame assembly, helps support the weight of the loaded trough.

The second wheels can refer to a pair of rear wheels located at the back portion of the wheelbarrow or other set of wheels. These wheels can be mounted to a support structure and configured to stabilize the wheelbarrow, especially during lifting, tilting, or transport. The second wheels can be height-adjustable relative to the trough or frame assembly.

The support structure can be a mechanical component or assembly that either carries the second wheels or supports the loading trough, depending on the configuration. It is adjustably connected to the frame assembly or trough and is designed to transfer loads and allow vertical position changes to improve balance, ergonomics, and stability.

The actuation mechanism can refer to the system responsible for enabling, locking, releasing, or controlling the movement of the support structure. It may include manual or powered components such as levers, gas springs, screw drives, or locking pins, and is configured to allow or restrict height adjustment of the support structure relative to the rest of the wheelbarrow.

The height adjustment mechanism can encompass the components that work together to change the vertical spacing between the second wheels and the loading trough. It can include the support structure and actuation mechanism and is configured to enable ergonomic adaptation, improve load distribution, and stabilize the wheelbarrow under varying conditions and user preferences.

Embodiments of the proposed wheelbarrow design can allow users to adapt the height of the device to their individual ergonomic needs and to varying load conditions. By adjusting the vertical spacing between the loading trough and the rear wheels, the user can influence the tilt angle and center of gravity, thereby reducing strain during lifting, pushing, and tipping operations. This is particularly beneficial for reducing lower back and wrist fatigue during extended use or when transporting heavy or unbalanced loads.

The use of two or more rear wheels provides greater lateral stability compared to conventional single-wheel designs. This reduces the risk of tipping during turns or when moving across uneven terrain. The user no longer needs to manually compensate for lateral forces to the same extent, allowing for safer and more controlled maneuvering, especially in professional or heavy-duty applications. The support structure and actuation mechanism together form a flexible system that can either raise or lower the loading trough or the rear wheels, depending on the implementation. This flexibility allows for both fixed and modular designs, which can be tailored to specific user needs or production constraints. The design accommodates both manual and assisted adjustment methods, such as screw drives or gas springs, enabling intuitive use while maintaining structural robustness.

This also enables the wheelbarrow's height adjustment mechanism to be offered as a modular unit, which can be retrofitted to existing wheelbarrows. This opens up additional use cases and allows manufacturers or users to improve the functionality of standard wheelbarrows without completely redesigning the entire device. The design thus supports a broader range of ergonomic and functional configurations while maintaining mechanical simplicity and durability.

According to a further aspect, the wheelbarrow can comprise a support structure that includes one or more mechanical members fixed or pivotally connected to at least one of the loading trough or the frame assembly, the frame assembly comprising the handles of the wheelbarrow, the support structure being configured to support the second wheels or the loading trough during height adjustment.

Mechanical members can refer to structural components such as bars, arms, brackets, or linkages that are either rigidly fixed or pivotally attached to other parts of the wheelbarrow, enabling movement or support during vertical adjustment.

This configuration allows the support structure to be flexibly integrated into different frame geometries. It provides structural adaptability and enables stable, ergonomic load transfer between the frame assembly, trough, and wheels during lifting or adjustment operations.

According to a further aspect, the wheelbarrow can comprise second wheels mounted on opposite ends of a shared axle, the axle being supported by the support structure and configured to remain substantially horizontal during adjustment of the vertical spacing between the loading trough and the second wheels.

A shared axle can be a single continuous shaft that laterally connects both rear wheels or multiple rear wheels, allowing them to rotate in parallel and stay aligned across the rear of the wheelbarrow. The wheels are preferably spaced laterally to match a distance between the two wheelbarrow handles, providing effective protection against tipping.

Keeping the axle substantially horizontal during height adjustment ensures symmetrical weight distribution and stable rolling performance. It minimizes lateral tipping and supports smooth rear movement, particularly on flat or slightly uneven terrain.

According to a further aspect, the wheelbarrow comprises second wheels each mounted on a respective support arm, the support arms being configured to pivot or slide to allow vertical adjustment of each second wheel relative to the loading trough, wherein each support arm is either independently connected to the frame assembly or connected to the other support arm via a linkage, the linkage being operatively connected to the frame assembly.

Support arms can be elongated mechanical linkages that carry individual wheels and are capable of independent pivoting or translational movement relative to the wheelbarrow frame assembly.

The described configuration can allow flexible support arm arrangements that adapt to different design needs or load conditions. Independent connections simplify modular installation, while linkage-based coupling enables coordinated movement for balanced height adjustment. Both options improve handling and user control when navigating uneven terrain or adjusting the load position, while maintaining structural compatibility with various frame assembly types.

According to a further aspect, each respective support arm comprises an upper portion fixedly connected to the frame assembly, a lower portion to which the second wheel is connected, and a joint arranged between the upper portion and the lower portion, the joint being configured to pivot the lower portion relative to the upper portion. Dividing the support arm into upper and lower sections connected by a pivot joint allows the rear wheel to follow vertical arcs during adjustment. This structure simplifies height changes while maintaining alignment and load transfer, and can be compactly integrated into various frame assembly geometries without obstructing wheelbarrow operation.

According to a further aspect, the joint comprises the actuation mechanism configured to lock and unlock the lower portion relative to the upper portion and/or a biasing element configured to urge the lower portion toward a locking position. The ability to lock the lower arm in place increases positional control during transport and when stationary. The biasing element helps reposition the lower arm for re-engagement, reducing user effort and ensuring that the joint remains aligned or automatically returns to a functional state after disengagement.

According to a further aspect, the wheelbarrow comprises second wheels that are caster wheels, each mounted on a swivel bracket and configured to rotate about a vertical axis and to support the rear portion of the wheelbarrow during movement and height adjustment.

Caster wheels can be rotatable wheels mounted in swiveling frame assemblies that enable 360-degree turning movement without requiring lifting or steering force from the user. The use of caster wheels enhances maneuverability in tight spaces or indoor areas. It allows the wheelbarrow to change direction smoothly, especially under load, and improves handling where pivot turns or fine control is needed.

According to a further aspect, the wheelbarrow comprises second wheels mounted to a support module that is detachably connected to the frame assembly, the support module including the support structure and the actuation mechanism, and being configured to adjust the vertical spacing between the second wheels and the loading trough.

A support module can be a self-contained subassembly that includes structural and functional components and can be easily attached to or removed from the main frame assembly of the wheelbarrow.

This modular configuration can allow for easy retrofitting or replacement of the height adjustment system. It supports customization, reduces downtime in case of repair, and enables compatibility with different wheelbarrow types without redesigning the entire unit.

According to a further aspect, the wheelbarrow comprises a support structure that includes a sliding carriage guided along one or more rails at the rear portion of the wheelbarrow, the actuation mechanism being configured to move the carriage vertically along the rails to adjust the spacing.

A sliding carriage can be a structural component that moves linearly along fixed rails, serving as a carrier for the second wheels or other load-bearing elements. The rails define the movement path and support controlled vertical adjustment.

Guiding the support structure along rails can enable precise, stable, and repeatable height adjustments. This configuration minimizes wobble or tilting during operation and supports smooth vertical motion with minimal user effort.

According to a further aspect, the wheelbarrow comprises a support structure mounted to the sliding carriage, the support structure being fixedly or pivotally connected to the sliding carriage such that the support structure moves vertically with the carriage to adjust the vertical spacing.

This configuration can help ensure that the support structure and the wheels it carries remain aligned during vertical movement. A pivoting connection can also allow for small angular adjustments to absorb shocks or follow terrain changes.

By combining guided movement with optional pivoting flexibility, embodiments of the system can be configured to provide both precise control and terrain adaptability, improving handling under variable ground conditions while maintaining structural simplicity.

According to a further aspect, the wheelbarrow comprises second wheels mounted on rearwardly extending angled arms, the arms being pivotally or telescopically connected to the frame assembly, and the actuation mechanism being configured to vary the angle or length of the arms to adjust vertical spacing.

Angled arms can be support elements extending diagonally from the frame assembly toward the rear wheels. Their adjustable connection allows the wheel position to be changed by rotating or extending the arms.

This layout can enable the rear wheels to be repositioned in a way that modifies the tilt and balance of the wheelbarrow. It supports both compact stowage and adjustable operating modes for different load types or user preferences.

According to a further aspect, the wheelbarrow can comprise a support structure that includes a telescopic tube assembly including an outer tube and an inner tube, the inner tube being slidable within the outer tube and configured to support the second wheels, and the actuation mechanism being configured to lock, release, or adjust the length of the telescopic tube to change the vertical spacing.

A telescopic tube assembly can consist of nested tubes that can extend or retract to vary the overall length. The tubes can slide relative to one another and may include integrated locking or damping features.

This types of embodiments can provide a compact, mechanically simple, and highly adjustable structure. It enables controlled height variation using minimal space and supports various actuation types, including manual levers or gas-assist mechanisms.

According to a further aspect, the wheelbarrow comprises a telescopic tube assembly where the outer tube is connected, at a first axial end portion, to the frame assembly and/or the loading trough, and the inner tube is connected, at a second axial end portion, to the support structure.

This configuration can help define the physical integration of the telescopic system, establishing a stable connection between the moving and fixed parts of the wheelbarrow. By clearly separating the mounting ends, the mechanism can help ensure consistent structural alignment during adjustment. It provides mechanical clarity, facilitates manufacturing, and allows modular replacement of parts when necessary.

According to a further aspect, the wheelbarrow further comprises a visual indicator configured to display the current vertical spacing between the second wheels and the loading trough.

A visual indicator may include mechanical scales, notches, windows, or digital displays that show the height setting of the wheelbarrow in real time.

Providing visual feedback during adjustment can improve the ease of use, allows repeatable positioning, and can enhance safety by making sure the wheelbarrow is properly set before operation or transport.

According to a further aspect, the wheelbarrow comprises second wheels that are spaced laterally apart by a distance substantially equal to the width of the loading trough or the frame assembly.

This layout can help ensure that the wheelbase corresponds to the overall width of the wheelbarrow, providing a broad stance for the rear wheels. Widening the wheel spacing relative to the frame assembly can increase lateral stability and reduces the chance of tipping during sharp turns or when moving over uneven terrain, especially when transporting top-heavy or unbalanced loads.

According to a further aspect, the wheelbarrow comprises a support structure that includes independent pivoting elements for each of the second wheels, configured to allow terrain-following motion and improve stability on uneven ground.

Independent pivoting elements can allow each rear wheel to move vertically relative to the other, accommodating surface irregularities and distributing weight more evenly across both wheels.

This can enhance ground contact and improve balance during operation on rough terrain. It can also reduce the need for manual compensation by the user and supports smoother, safer transport across varying environments.

### BRIEF DESCRIPTION OF THE DRAWINGS

For a better understanding of the present invention and its advantages, reference is now made to the following description in conjunction with the accompanying drawings. In the following, the invention will be explained in more detail with reference to exemplary embodiments indicated in the schematic figures of the drawings, in which:

FIG. 1 shows a schematic representation of a height-adjustable wheelbarrow according to a preferred embodiment of the invention;

FIG. 2 shows a schematic representation of a height-adjustable wheelbarrow according to the preferred embodiment of the invention;

FIG. 3 shows a schematic representation of a height-adjustable wheelbarrow according to a further preferred embodiment of the invention;

FIG. 4 shows a schematic representation of a height-adjustable wheelbarrow according to a further preferred embodiment of the invention; and

FIG. 5 shows a schematic representation of a height-adjustable wheelbarrow according to a further preferred embodiment of the invention.

Unless otherwise indicated, like reference signs denote like elements of the drawings.

### DETAILED DESCRIPTION

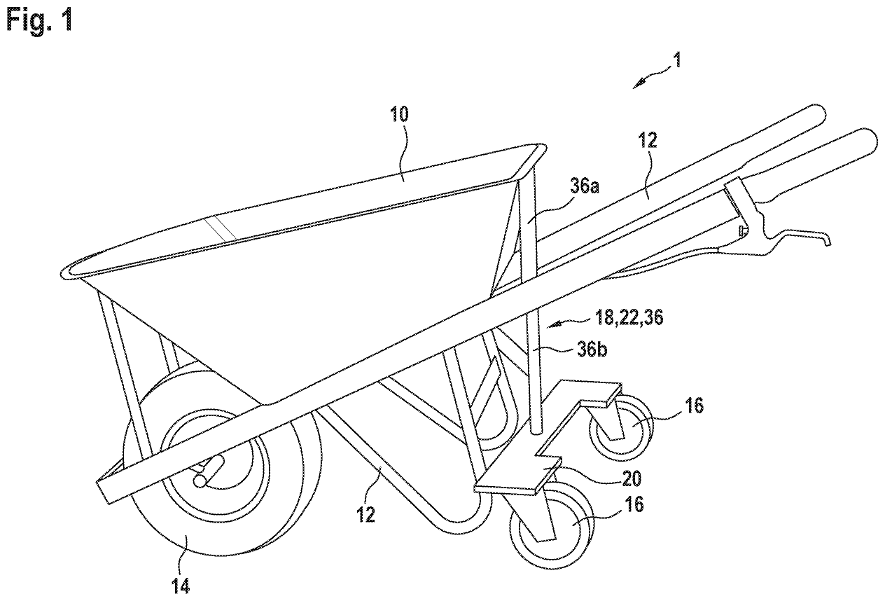

FIG. 1 shows a height-adjustable wheelbarrow 1, comprising a loading trough 10 supported by a frame assembly 12, a first wheel 14 arranged at a front portion of the wheelbarrow 1, wherein the frame assembly 12 is structured to have the first wheel 14 rotatably coupled thereto and to act as a ground engaging leg to support the wheelbarrow 1 at rest, two or more second wheels 16 arranged at a rear portion of the wheelbarrow 1, and a height adjustment mechanism 18 configured to adjust a vertical spacing between the loading trough 10 and the second wheels 16.

The height adjustment mechanism 18 comprises a support structure 20 carrying the second wheels 16 or the loading trough 10, and an actuation mechanism 22 configured to lock, release or control adjustment of a vertical position of the support structure 20 relative to the other of the loading trough 10 or the second wheels 16.

The support structure 20 comprises one or more mechanical members fixed or pivotally connected to at least one of the loading trough 10 or the frame assembly 12, the support structure 20 being configured to support the second wheels 16 or the loading trough 10 during height adjustment.

The second wheels 16 are mounted on opposite ends of a shared axle 24, the axle 24 being supported by the support structure 20 and configured to remain substantially horizontal during adjustment of the vertical spacing between the loading trough 10 and the second wheels 16.

The second wheels 16 comprise caster wheels, each mounted on a swivel bracket, the caster wheels being configured to rotate about a vertical axis and to support the rear portion of the wheelbarrow 1 during movement and height adjustment.

The second wheels 16 are mounted to a support module detachably connected to the frame assembly 12, the support module including the support structure 20 and the actuation mechanism 22 and being configured to adjust the vertical spacing between the second wheels 16 and the loading trough 10.

The support structure 20 comprises a sliding carriage guided along one or more rails at the rear portion of the wheelbarrow 1, the actuation mechanism 22 being configured to move the carriage vertically along the rails to adjust the spacing.

The support structure 20 is mounted to the sliding carriage, the support structure 20 being fixedly or pivotally connected to the sliding carriage such that the support structure 20 moves vertically with the carriage to adjust the vertical spacing.

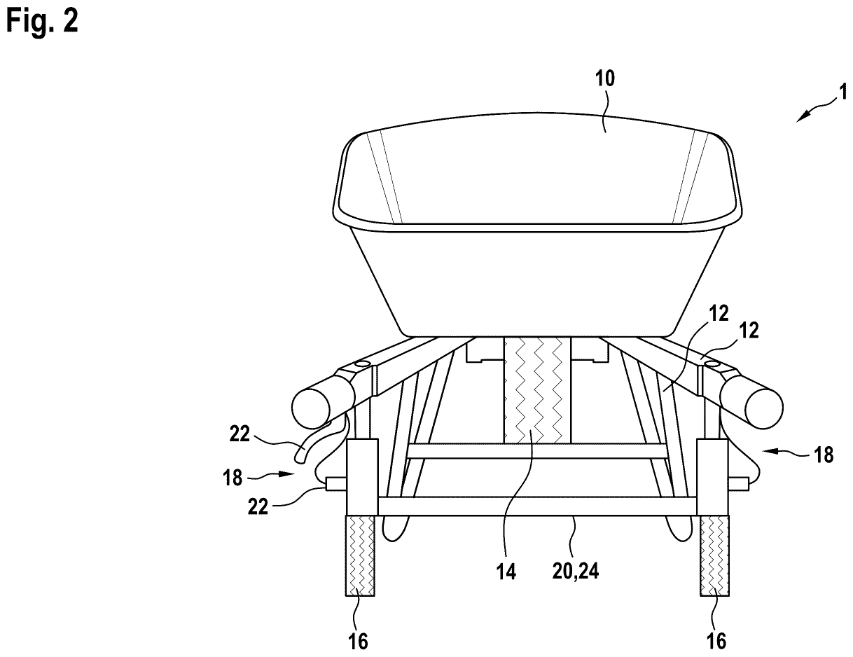

FIG. 2 shows a schematic representation of a height-adjustable wheelbarrow 1 according to the preferred embodiment of the invention.

The support structure 20 comprises a telescopic tube assembly 36 including an outer tube 36a and an inner tube 36b, the inner tube 36b being slidable within the outer tube 36a and configured to support the second wheels 16, and wherein the actuation mechanism 22 is configured to lock, release, or adjust the length of the telescopic tube to change the vertical spacing.

The outer tube 36a is connected, at a first axial end portion, to the frame assembly 12 and/or the loading trough 10, and the inner tube 36b is connected, at a second axial end portion, to the support structure 20.

The second wheels 16 are spaced laterally apart by a distance substantially equal to the width of the loading trough 10 or the frame assembly 12.

The wheelbarrow 1 further comprises a visual indicator not shown in the drawings configured to display the current vertical spacing between the second wheels 16 and the loading trough 10.

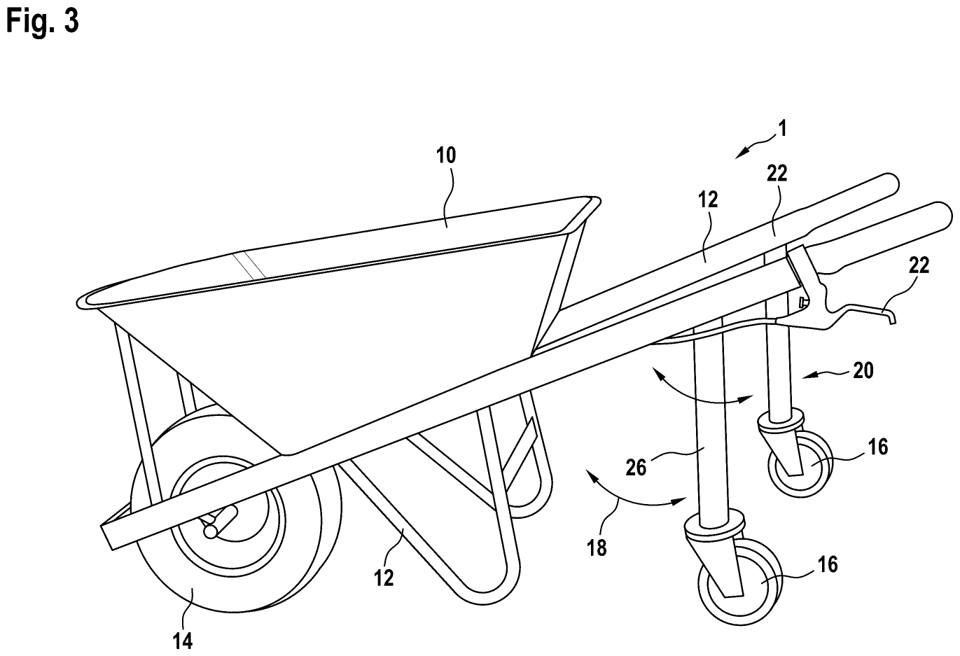

FIG. 3 shows a schematic representation of a height-adjustable wheelbarrow 1 according to a further preferred embodiment of the invention.

According to a further embodiment, the second wheels 16 are each mounted on a respective support arm 26, the support arms 26 being configured to pivot, for example by means of a joint 28, or slide to allow vertical adjustment of each second wheel relative to the loading trough 10, wherein each support arm 26 is either independently connected to the frame assembly 12 as shown in FIG. 3 or alternatively connected to the other support arm 26 via a linkage, the linkage being operatively connected to the frame assembly 12 not shown in the drawings.

Alternatively or in addition, the support structure 20 may include independent pivoting elements for each of the second wheels 16, configured to allow terrain-following motion and improve stability on uneven ground.

The actuation mechanism 22 is configured to lock, release or control adjustment of the support arms 26 individually or together in order to adjust the vertical position of the two or more second wheels connected to the support arms 26 relative to loading trough 10.

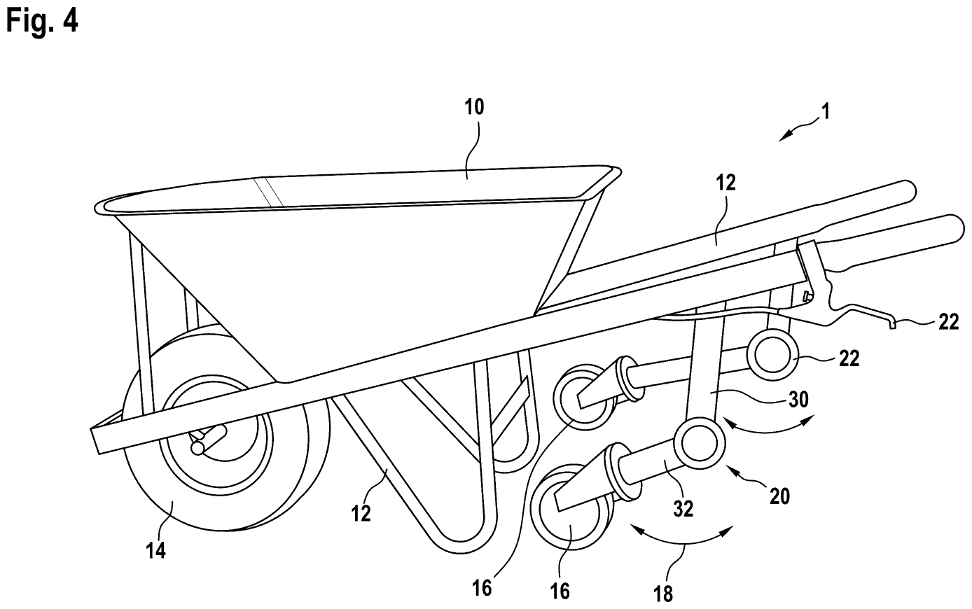

FIG. 4 shows a schematic representation of a height-adjustable wheelbarrow 1 according to a further preferred embodiment of the invention.

According to a further embodiment, each respective support arm 26 comprises an upper portion 30 fixedly connected to the frame assembly 12, a lower portion 32 to which the second wheel is connected and a joint 28 arranged between the upper portion 30 and the lower portion 32, the joint 28 being configured to pivot the lower portion 32 relative to the upper portion 30.

The joint 28 comprises the actuation mechanism 22 configured to lock and unlock the lower portion 32 relative to the upper portion 30 and/or a biasing element configured to urge the lower portion 32 toward a locking position.

Furthermore, the height adjustment mechanism 18 for a wheelbarrow 1 shown in FIG. 1 to FIG. 4 may be a standalone unit that may be retrofitted to any conventional wheelbarrow 1.

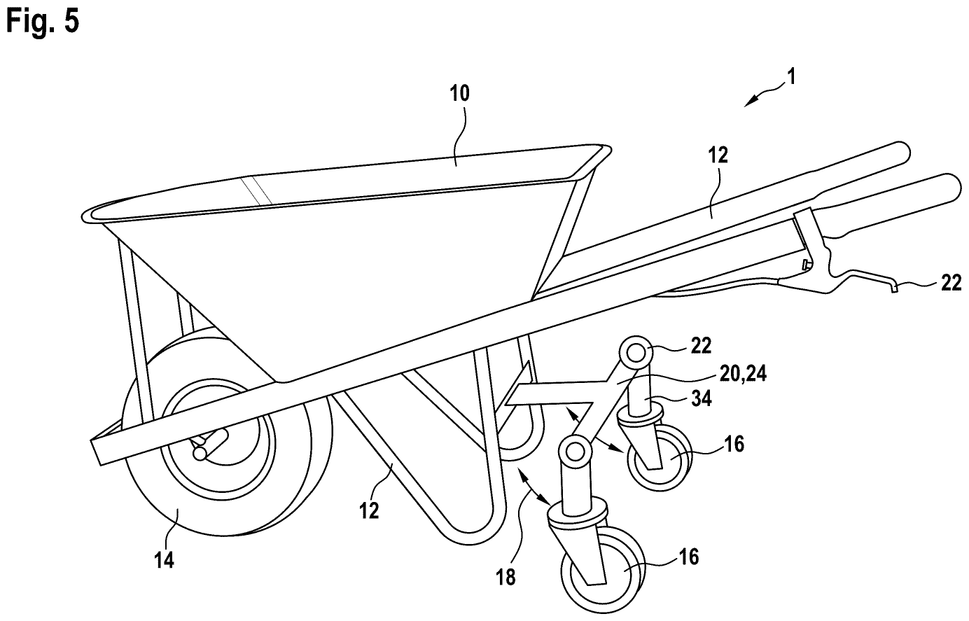

FIG. 5 shows a schematic representation of a height-adjustable wheelbarrow 1 according to a further preferred embodiment of the invention.

The second wheels 16 are mounted on rearwardly extending angled arms 34, the arms being pivotally shown in FIG. 5 or telescopically not shown in the drawings connected to the frame assembly 12, and the actuation mechanism 22 being configured to vary the angle or length of the arms to adjust vertical spacing.

The actuation mechanism 22 comprises respective joints that enable pivoting of the angled arms 34. The positions of the angled arms 34 shown in FIG. 5 is a driving position, in which the wheelbarrow contracts the ground with the first wheel 14 and the second wheels 16, wherein the frame assembly 12 is lifted up from the ground. In a stowed position not shown in FIG. 5 the angled arms 34 are pivoted such that the wheelbarrow is lowered and rests on the with the first wheel 14 and the frame assembly 12.

The structure and design is identical to the embodiments wheelbarrow 1 shown in FIG. 1 to FIG. 4, the height adjustment mechanism 18 comprising a support structure 20, an actuation mechanism 22 operatively coupled to the support structure 20 and configured to lock, release, or control adjustment of a vertical position of the support structure 20, and two rear wheels mounted to the support structure 20, wherein the support structure 20 is configured to be mounted to a frame assembly 12 or a loading trough 10 of the wheelbarrow 1 to adjust a vertical spacing between the rear wheels and the loading trough 10.

It will be apparent to those skilled in the art that numerous modifications and variations of the described examples and embodiments are possible in light of the above teaching. The disclosed examples and embodiments are presented for purposes of illustration only. Other alternate embodiments may include some or all of the features disclosed herein. Therefore, it is the intent to cover all such modifications and alternate embodiments as may come within the true scope of this invention.

1. A height-adjustable wheelbarrow, comprising:
a loading trough supported by a frame assembly;
a first wheel arranged at a front portion of the wheelbarrow, wherein the frame assembly is structured to have the first wheel rotatably coupled thereto and to act as a ground engaging leg to support the wheelbarrow at rest;
two or more second wheels arranged at a rear portion of the wheelbarrow; and
a height adjustment mechanism configured to adjust a vertical spacing between the loading trough and the second wheels, the height adjustment mechanism comprising:
a support structure carrying the second wheels or the loading trough; and
an actuation mechanism configured to lock, release or control adjustment of a vertical position of the support structure relative to the other of the loading trough or the second wheels;
wherein the support structure comprises a single, centrally-located adjustable member arranged laterally between the two or more second wheels, the single, centrally-located adjustable member carrying both of the two or more second wheels and connecting the two or more second wheels to the frame assembly and/or the loading trough, and wherein the actuation mechanism comprises a single locking element operable to adjust a vertical position of the single, centrally-located adjustable member such that the vertical spacing between the loading trough and the two or more second wheels are adjusted in unison via adjustment of the vertical position of the single, centrally-located adjustable member.

2. The wheelbarrow of claim 1, wherein the support structure comprises one or more mechanical members fixed or pivotally connected to at least one of the loading trough or the frame assembly, the frame assembly comprising the handles of the wheelbarrow, the support structure being configured to support the second wheels or the loading trough during height adjustment.

3. The wheelbarrow of claim 1, wherein the second wheels are mounted on opposite ends of a shared axle, the axle being supported by the support structure and configured to remain substantially horizontal during adjustment of the vertical spacing between the loading trough and the second wheels.

4. The wheelbarrow of claim 1, wherein each of the second wheels is mounted on a respective support arm, the support arms being connected to the frame assembly and configured to pivot or slide to allow vertical adjustment of each second wheel relative to the loading trough.

5. The wheelbarrow of claim 4, wherein each respective support arm comprises an upper portion fixedly connected to the frame assembly, a lower portion to which the second wheel is connected and a joint arranged between the upper portion and the lower portion, the joint being configured to pivot the lower portion relative to the upper portion.

6. The wheelbarrow of claim 5, wherein the joint comprises the actuation mechanism configured to lock and unlock the lower portion relative to the upper portion and/or a biasing element configured to urge the lower portion toward a locking position.

7. The wheelbarrow of claim 1, wherein the second wheels comprise caster wheels, each mounted on a swivel bracket, the caster wheels being configured to rotate about a vertical axis and to support the rear portion of the wheelbarrow during movement and height adjustment.

8. The wheelbarrow of claim 1, wherein the second wheels are mounted to a support module detachably connected to the frame assembly, the support module including the support structure and the actuation mechanism and being configured to adjust the vertical spacing between the second wheels and the loading trough.

9. The wheelbarrow of claim 1, wherein the support structure comprises a sliding carriage guided along one or more rails at the rear portion of the wheelbarrow, the actuation mechanism being configured to move the carriage vertically along the rails to adjust the spacing.

10. The wheelbarrow of claim 9, wherein the support structure is mounted to the sliding carriage, the support structure being fixedly or pivotally connected to the sliding carriage such that the support structure moves vertically with the carriage to adjust the vertical spacing.

11. The wheelbarrow of claim 1, wherein the second wheels are mounted on rearwardly extending angled arms, the arms being pivotally or telescopically connected to the frame assembly, and the actuation mechanism being configured to vary the angle or length of the arms to adjust vertical spacing.

12. The wheelbarrow of claim 1, wherein the support structure comprises a telescopic tube assembly including an outer tube and an inner tube, the inner tube being slidable within the outer tube and configured to support the second wheels, and wherein the actuation mechanism is configured to lock, release, or adjust the length of the telescopic tube to change the vertical spacing.

13. The wheelbarrow of claim 12, wherein the outer tube is connected, at a first axial end portion, to the frame assembly and/or the loading trough, and the inner tube is connected, at a second axial end portion, to the support structure.

14. The wheelbarrow of claim 1, further comprising a visual indicator configured to display the current vertical spacing between the second wheels and the loading trough.

15. The wheelbarrow of claim 1, wherein the second wheels are spaced laterally apart by a distance substantially equal to the width of the loading trough or the frame assembly.

16. The wheelbarrow of claim 1, wherein the support structure includes independent pivoting elements for each of the second wheels, configured to allow terrain-following motion and improve stability on uneven ground.

17. A height adjustment mechanism for a wheelbarrow, comprising:
a support structure;
an actuation mechanism operatively coupled to the support structure and configured to lock, release, or control adjustment of a vertical position of the support structure; and
two rear wheels mounted to the support structure;
wherein the support structure is configured to be mounted to a frame assembly or a loading trough of the wheelbarrow to adjust a vertical spacing between the rear wheels and the loading trough, and wherein the support structure comprises a single, centrally-located adjustable member arranged laterally between the two rear wheels, the single, centrally-located adjustable member carrying both of the two rear wheels and connecting the two rear wheels to the frame assembly or the loading trough, and wherein the actuation mechanism comprises a single locking element operable to adjust a vertical position of the single, centrally-located adjustable member such that the vertical spacing between the two rear wheels and the loading trough are adjusted in unison via adjustment of the vertical position of the single, centrally-located adjustable member.

18. The wheelbarrow of claim 17, wherein the single, centrally-located adjustable member terminates at a C-shaped support, the two or more second wheels being mounted to the C-shaped support on opposite sides of the single, centrally-located adjustable member.

19. The wheelbarrow of claim 1, wherein the single, centrally-located adjustable member terminates at a C-shaped support, the two or more second wheels being mounted to the C-shaped support on opposite sides of the single, centrally-located adjustable member.
